(19) United States
(12) Patent Application Publication
(10) Pub. No.: US 2005/0060685 A1
(43) Pub. Date: Mar. 17, 2005

(54) Program generator

(76) Inventors: Ingo Franz, Berlin (DE); Steffen Linke, Berlin (DE)

Correspondence Address: Law Offices;Mallinckrodt & Mallinckrodt, Suite 510, 10 Exchange Place, Salt Lake City, UT, 84111, US

(21) Appl. No.: 10/938,228

(22) Filed: Sep. 10, 2004

(30) Foreign Application Priority Data
Sep. 11, 2003 (DE) 103 42 226.9

(51) Int. Cl. G06F 9/44

(52) U.S. Cl. 717/109; 717/113

(57) ABSTRACT

The invention relates to a computer device for the generation of executable programs, comprising a user interface for entering a model based on a program with a executable commands, a generator for generating of individual programming code from the model, a state machine for executing the executable program, means for providing predefined programming code which has the form of at least one basic class or other predefined code for providing repeating algorithms. The user interface has input means for inputting executable commands in a graphical form. The entry points into the program are formed by parts of the predefined programming code for the state machine. The model also comprises graphic symbols representing instantiated classes, and the user interface comprises means for defining a direct relation between the input and output of data by a program user and attributes of the instantiated classes.

### BACKGROUND OF THE INVENTION

1. Technical Field

The invention relates to a device for the generation of executable programs, comprising a user interface for entering a model based on a program, a generator for generating individual programming code from said model, a state machine for executing the program based on said programming code, and predefined programming code in the form of at least one basic class or other pre-defined code for providing repeating algorithms.

A model shall be generally defined here as an image of the reality which is simulated and administered. This can be the graphic representation of administration processes, the basis for the generation of invoices or the like. Such a graphic representation makes use of graphic elements, such as arrows, boxes, circles, etc. A model, however, can represent the reality also directly by means of punched cards, binary code, or programming code, i.e., text in a program language. This kind of representation in the form of programming is not very clear and may be confusing. In this application, modelling is defined only as the graphic representation of a model in a coordinate system. Text elements, however, may form a part of such a model.

A user interface, for example, is a monitor. On this monitor the model can be shown. It can be generated and modified with a keyboard and a mouse. Programming code is a text in a programming language, such as PASCAL, C, Java, or the like. A programming code can be generated with a generator. A generator can generate a text portion “automatically”, which is not possible with a simple editor, such as Microsoft Word or the like. In an editor, the text portion is manually entered as such by means of a keyboard or the like.

A state machine is a finite state machine. This is an algorithm, which is used to define a series of program steps (actions) in a table. Possible input data can be allocated to set programming states. For each allocation, the executable actions and the following state resulting therefrom can be defined.

For generating programs, data processing installations usually use programming languages, such as C, PASCAL or Java. The programmer must know the commands of this programming language. Depending on the language this may require considerable knowledge. The program is produced in the form of a text, which can be edited as a listing and in the form of tables. Therein, it is particularly difficult to program the various interfaces connecting the user and a plurality of periphery devices. Complex programs become extremely unmethodical and difficult to overview. Furthermore, the programmer is limited to the features of the programming language used. Advantages provided by different programming languages normally cannot be used.

The programmer often illustrates the flow processes, which have to be programmed in the form of a graphical representation. Such a graphical representation can be produced manually with a pencil or it can be drawn on the computer. However, such a representation does not contribute to the programming process as such, apart from the representation of the flow processes on the monitor or the paper. Using such a representation, such as a flow diagram, the programming code is generated. For this purpose the programmer enters the required text. Debugging permits recognition of errors, if present. This is very time consuming. Furthermore, it is known to provide configuration options. With such a configuration the program behavior can be influenced after the programming has been finished. An example is the entering of a letter head, adapting the program to certain hardware, or the like.

The programming process can be generally divided into four levels: First of all the data storage (persistence) must be organized. The required data formats for the used data are set. Furthermore, structures are defined, which are used for storing the data on a hard disc, for example. The relations between the data are defined, also.

In a further level the logic parts, including the business logic and the specific realization, are programmed. The required objects, such as, for example, address components, persons, recipients for invoices and the like, are defined. Objects normally consist of its name, corresponding to the denotation of the object, attributes, corresponding to the characteristics of the object, and methods, corresponding to the possible executable actions.

In a third level the control of the flow processes, including the dialogues and the process control, are programmed. The control of the flow processes determines when certain actions are carried out. It is set, which window is opened after which process, which calculation is effected by clicking which button, etc. Such flow processes are very often illustrated by flow diagrams.

In a last level the presentation, including layout and design, are programmed. Colors, window sizes, scripts, position and form of buttons, backgrounds, acoustical effects, and the like are set.

2. Description of the Prior Art

Programs are known, which are generally called CMS (Content Management System), for example ColdFusion, Designer Tools, for example Dreamweaver and HTML-Editors. Such programs provide the possibility to visually generate the program level of the layout. Also flow processes can be generated by such visualization. However, such flow processes result directly from the buttons and links, provided on the user interface. Furthermore, a program influencing by configuration is effected. A true modelling of the flow processes, however, is not possible. Data base accesses and specific objects must be programmed in a programming language.

For this purpose, the manual generation of programming code is necessary. Such programs are only suitable for internet applications.

Furthermore integrated development environments (IDE) are known. Such integrated development environments also support the programmer during the programming of the layout. Data base accesses and specific objects, however, still have to be manually programmed. The objects which shall be used can be shown. The generation of programming code is necessary for their use. A support of the flow processes is not provided.

In the known process with modelling tools and work flow tools, tools are used which are adapted for the modelling of the flow processes. For this purpose, a plurality of graphic symbols is provided. Such symbols are, for example, sequence, loop, compare, parallel flow, switch, operation, news, assign, etc. Then the modelling of classic flow diagrams is carried out. The models are interpreted by a server. The server communicates with data bases through programmable interfaces. Possibilities of modelling the layout, the application-specific logic or the data storage do not exist.

The term “Case Tools” designates object orientated modelling tools. Programming code is generated exclusively for the application-specific logic. Case Tools support the user with the generation of UML-diagrams (UML: Unified Modelling Language). However, Case tools do not support all UML-diagrams, but only class and sequence diagrams. They are, therefore, not suitable for the programming of the flow processes, the data storage and the layout due to the complex form of programming of such levels.

The term “MDA” (Model Driven Architecture) has been created by the so called OMG (Object Management Group). It forms a standard. MDA describes the co-operation of modules created from the UML-language and makes them compatible. Furthermore, the standard defines a framework for programming applications which can be configured in a fixed configuration. A run time environment does not exist. For the generation of a finished program an implementing step has to be carried out after modelling. Only after implementing the program according to this standard, the development process is finished. No provision is made for testing during the modelling process. The MDA standard provides for the co-operation with outside components. Interfaces must be defined for this purpose and the platform-independent model must be adapted to the concepts of the technical platform. For developing a program according to the MDA standard the respective classes are modelled. A class is defined as a programming code representing an object with its name, attributes and methods.

When modelling according to the MDA, standard generated code is provided. Additionally, interfaces must be defined which are used for addressing the code. Such additional programs can be configured, but the configuration does not directly access the modelling of the application-specific logic, but must be adapted if the application-specific logic is changed. Each change of the model must be manually adapted within the executing framework. A modelling of the layout is not provided. Modelling of data bases in a classic sense (for example Entity-Relationship-Model) and explicit OR-mapping (allocation of object orientated programming for relational data base tables) is not provided. MDA, therefore, is a mixture of code generated using a model and code which can be influenced by configuration, such configuration not being part of the modelling. For running such code frameworks, libraries and external components must be used which are generated in a separate development process.

### DISCLOSURE OF THE INVENTION

It is an object of the invention to facilitate the creation of executable programs and to provide a device for the generation of complete programs which are ready to run. According to the invention this object is achieved with a computer device for the generation of executable programs, comprising
(a) a user interface adapted to receive input data and provide output data, said user interface being provided for entering a model based on a program, said program comprising a plurality of executable commands;
(b) a generator means for generating individual programming code from said model;
(c) a state machine for executing said executable program based on said programming code;
(d) means for providing predefined programming code, said predefined programming code having the form of at least one basic class or other predefined code for providing repeating algorithms;
(e) said user interface having input means, said input means being designed such that the input of said executable commands is effected at least partially in a graphical form;
(f) means for selecting an entry point in parts of said predefined programming code for the state machine,
(g) said model based on said program comprising graphic symbols representing instantiated classes, and
(h) the user interface comprising means for defining a direct relation between said input and output of data by a program user and attributes of said instantiated classes.

Here, instantiated classes are defined, as normal in the object oriented programming, as closed address areas of program data and programming code in the storage means. Program users comprise both human users and other programs.

With such a device it is possible to create programs exclusively on a graphic basis. The process flow control and the application-specific logic are modelled, i.e., programmed in a graphical way. This means that no text need be entered in the form of commands or the like by means of a keyboard. The programmer does not have to learn complex programming languages. He does not need specific knowledge for the text input. He is now in the position to work with the mouse or other means for inserting commands in graphical form. However, the commands are not only inserted in graphical form. The graphic is directly processed to a running program. For this purpose pre-programmed programming code is used which serves as an entry point. By directly forming instantiated classes, for example in the working storage, and the direct cooperation with the state machine, the program is able to run at any time. It can be tested during the development. The programmer need not program any interfaces.

For realizing specific tasks, however, certain text portions, for example the denotation of graphic elements or formulas, may be inserted. A possibility for manually inserting programming code can also be provided.

Preferably the states and the state transitions of the state machine can be graphically inserted. Thereby the programmer has the best possible overview over the relationships. This ensures that also the order of commands depending on previously executed commands can be modelled.

Storage means for persistent storage of data can be provided and the instantiated classes can comprise means for the persistent access to such data. Persistant storage is the permanent storage, for example in a hard disc memory. In this case a data base can be administered with the program.

Furthermore, means for the graphic design of the surface of the executable program can be provided. Then not only is an executable program generated, but also an agreeable surface. Preferably the means for the graphic design comprise inserting means for graphically entering presentation elements of the graphic design. Presentation elements are, for example, images or texts.

In a particularly preferred embodiment of the invention, means are provided for storing the model based on the program in one continuous structure, especially in one single file. Such files are easy to copy or to send away and therefore easy to handle. All programming works achieved up to a certain point can be called up from this file.

Preferably the persistent data are interconnected and the model comprises graphic symbols representing such interconnections.

According to the invention a method for the generation of executable programs is provided comprising the method steps of:
(a) generating a graphic chart representing a model based on a program by inserting executable commands at least partially in graphical form;
(b) generating individual programming code from said model;
(c) executing said program based on said programming code by means of a state machine;
(d) providing predefined programming codes in the form of at least one basic class or other predefined code for providing for repeating algorithms, and executing said predefined programming codes;
(e) providing a state machine for executing said predefined programming codes and entering into said predefined programming code by means of said state machine,
(f) forming instantiated classes by means of graphic symbols, and
(g) using direct interfaces between instances and program users which are included in the model and which are generated by said state machine using said base classes.

With such a method all four levels, i.e., layout, process flow control, application-specific logic, and data storage, are considered. The thus created application is complete. The mechanisms of code generation from object orientated modelling (application-specific logic) are connected with the principles of finite state machines (process flow control) and its modelling. The use of open interfaces allows the use of existing data bases or professional layouts.

Further modifications of the invention are subject matter of the sub-claims. A preferred embodiment of the invention is described below in greater detail with reference to the accompanying drawings.

Further advantages and features which are part of the invention become more clear in the description of the preferred embodiment. While the embodiment is described using a specific example, it is, however, understood, that the invention is not limited to this example and that a plurality of modifications is possible, which fall within the scope of the invention as claimed in the claims.

### BRIEF DESCRIPTION OF THE DRAWINGS

FIG. 1 is a schematic illustration of the relationships of the individual components of a device for the graphic generation of executable programs.

FIG. 2 is a detailed illustration of the development file.

FIG. 3 shows a typical user interface for modelling the application-specific logic for the example of creating an invoice.

FIG. 4 shows the user interface of FIG. 3 with an editor for entering and/or changing a method for the example of creating an invoice.

FIG. 5 shows a user interface for modelling the process flow control for the example of creating an invoice.

FIG. 6 shows a user interface for modelling the data storage for the example of creating an invoice.

FIG. 7 shows a dialogue which is completely modelled for entering data.

FIG. 8 shows a start dialogue which is completely modelled for selecting an event by the user.

FIG. 9 shows a dialogue for entering or changing consumption values and starting a calculation.

FIG. 10 is a dialogue for displaying a calculated amount.

FIG. 11 is the user interface of FIG. 3 with additional objects of the application-specific logic.

FIG. 12 illustrates an editor for entering and/or modifying of a method.

FIG. 12a shows the user interface of FIG. 5 with additional elements of the process flow control.

FIG. 13 shows another dialogue which is completely modelled for selecting an event by the user.

FIG. 14 shows a dialogue which is completely modelled for selecting an event and selecting one or more data which are displayed.

FIG. 15 shows a dialogue which is completely modelled for starting an event, entering a value and displaying a value.

FIG. 16 shows a dialogue which is completely modelled and wherein the values of different entities having a relation are displayed.

FIG. 17 represents a basic class in JAVA programming language.

FIGS. 18a to c represent the development file in XML-format.

### DETAILED DESCRIPTION OF A PREFERRED EMBODIMENT

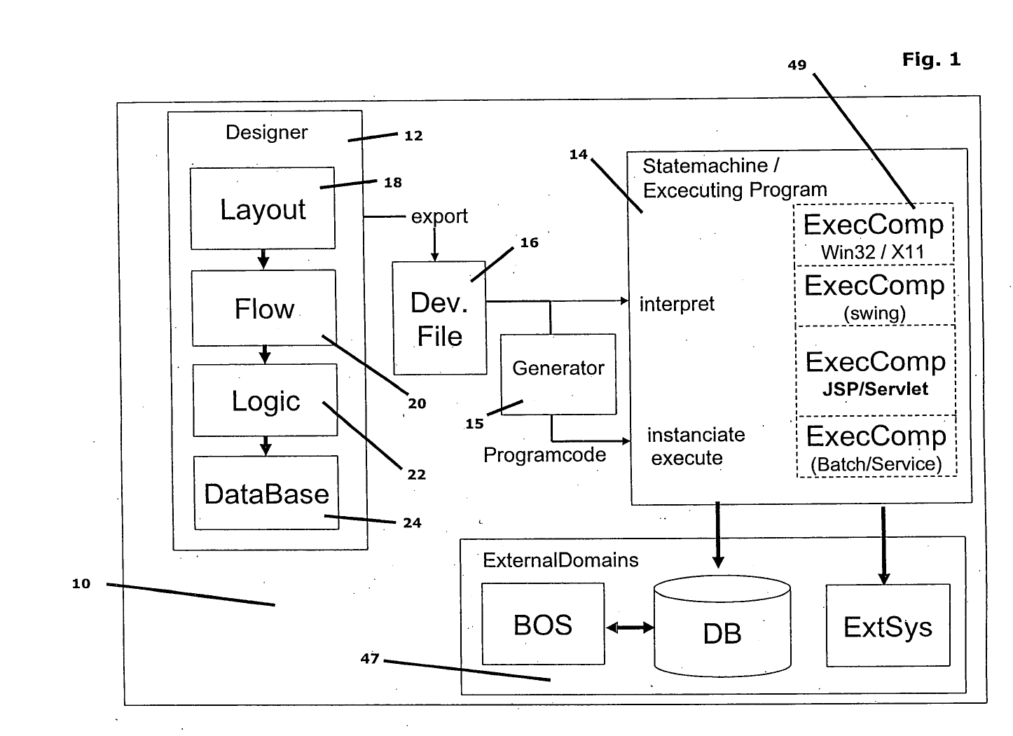

The preferred embodiment comprises a personal computer 10 with conventional hardware and peripheral equipment, including a monitor, a keyboard, a mouse and a connection to a network. An operating system, for example MS Windows, a compiler and a data base are installed on the computer. The structures for the graphical generation of executable programs on the computer 10 are illustrated in FIG. 1.

A designer program generally designated with numeral 12 and an executable program 14 are provided. For the development of a new program those two programs are called. The structures generated during the development are stored in a development file as a temporary or final development result. The development file 16 is generated by the designer program 12.

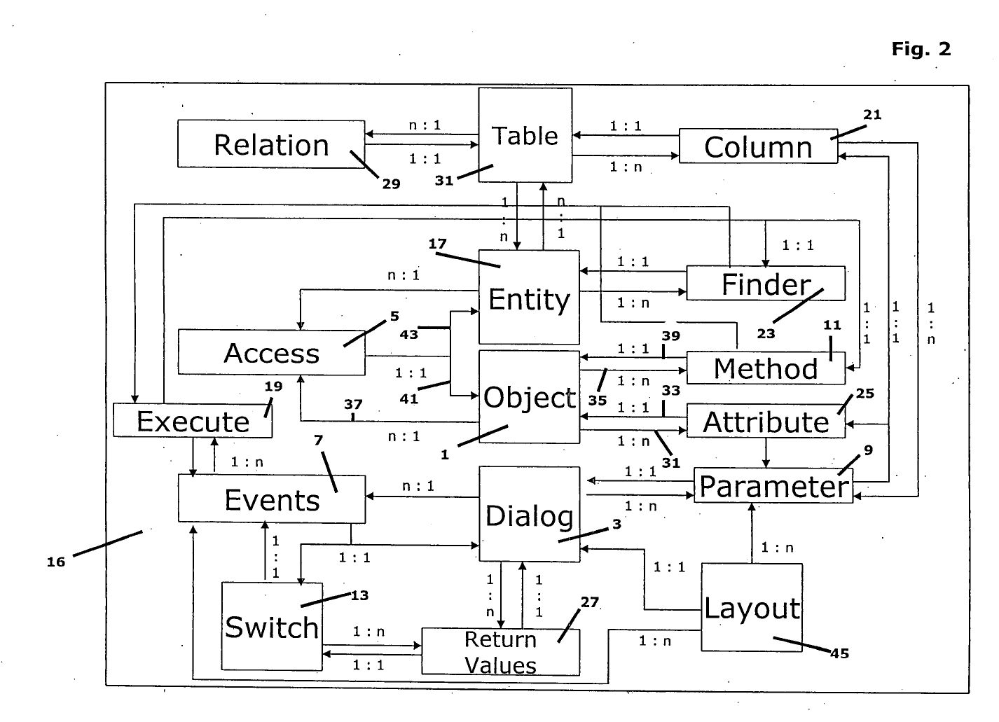

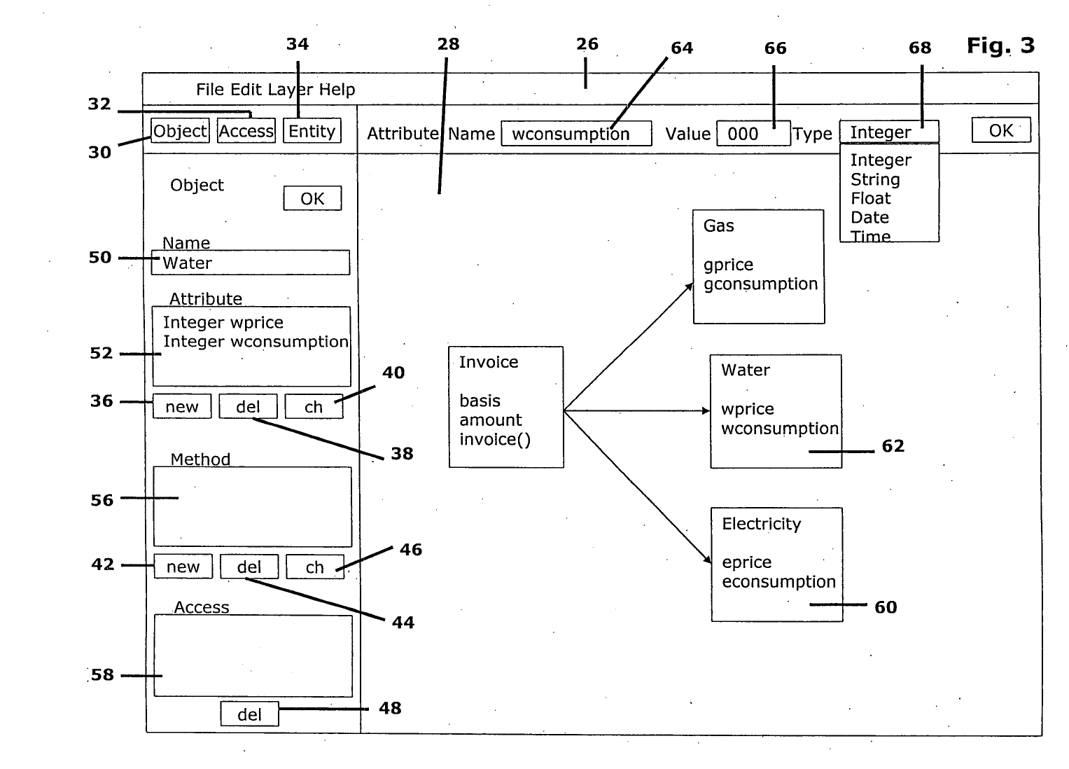

Several drawing windows or areas are provided for the user for the individual modules of the modelling. The drawing areas are provided for each of the four levels of the application to be created. The designer program 12 comprises an area 18 for the generation of the layout, an area 20 for the generation of the process flow control, an area 22 for the generation of the application-specific logic and an area 24 for the data storage. The individual elements of the modelling correspond to the contents of the development file. In FIG. 3 to 6 the main areas of the designer program 12 are shown in greater detail. Using the development file as it is described in greater detail below with reference to FIG. 2 a generator 15 generates programming code which is executed by the executable program at a later stage.

The rectangle designated with numeral 49 in FIG. 1 show that the executing program 14 and the state machine can be produced in different architectures for different platforms.

The rectangle designated with numeral 47 in FIG. 1 represents the access of the state machine to a data base and other external systems and the exchange between the data base and a back office system.

On a first level, an example of which is shown in FIG. 3, the application-specific logic of the application is modelled. In this level the instances are directly modelled.

It is generally distinguished between two kinds of objects which can be modelled: object and entity. Objects may have attributes such as integer, string, float, time, date and externally defined attributes.

In FIG. 3 an example for one window of the user interface for the generation of the application-specific logic is shown. The window comprises a menu 26, a drawing area 28, buttons 30 to 48 and boxes 52 to 58 for indicating information. It is demonstrated here how to generate an executable program with such a user interface using the example of an invoicing program. The object of the program is to produce an invoice with a total amount, which adds up from an invoice for electricity, an invoice for water and an invoice for gas. Electricity, water and gas are characterized by a unit price and a consumption. This example is kept simple and is for illustrating purpose only. Any other task and more complex tasks may also be programmed in the same way.

First of all objects have to be generated. Such objects have attributes and a method for computing the amount which must be invoiced.

The object is generated by activating button 30. If the button 30 is activated it is possible to draw a rectangle, for example the rectangle 60 or 62 on the drawing area 20 with the mouse provided for the computer 10. For such a rectangle representing an object the object name can be entered in input area 50. Further details of this object can also be entered. The object represented by the rectangle is here called “water”. Access or entities can be generated by activating buttons 32 or 34 instead of objects.

By activating button 36 a feature, i.e. an attribute can be allocated to the object. The name of this new attribute—here it is “water consumption”—is entered into an input area 64. Furthermore the attribute receives the start value “000”, which can be entered in an input area 66. A selection menu is provided for selecting the type of the attribute. In the present example the water consumption is an integer. Therefore, the type “integer” is selected. In other cases types like “date”, “time” or the like may be selected.

In such way the objects are defined, which are in the present example: gas, water, electricity, and invoice, i.e., the total amount. The object “invoice” has the attributes “basis”, corresponding to a basic fee, “amount,” corresponding to the result of the calculation of the total amount and a method.

Methods can be defined for the objects. Entities point at data base tables. Finders can be defined at such entities. The finders load data sets from a table into the instances in the working storage. The data sets fulfil the selection criteria defined by the finder. Predefined methods can be called for objects and entities. Such methods can be “create” and “delete”. Such predefined methods can be called as a method for the entity to create or delete a data set. Entities automatically have attributes, derived from the columns of the table on which the entities point. Such attributes have n dimensions, for example an array.

Methods and finder are executable and have return values. This means that after executing the method a value is provided for further processing. This may be the result of a calculation formula, for example, for a method. It may also be the number of hits of a finder, for example, fulfilling the characteristics defined by the finder and loaded into the working storage. By applying access arrows between the objects it is defined which of these executable methods or finders are permitted to access other objects. Furthermore, objects can import or use external logic. Such external objects are, for example, CORBA objects or further external programming code.

The methods and finder can be edited with an additional editor. The methods can also be modelled by sequence diagrams. The finders can be modelled by graphically selecting logic, model-related conditions. Apart from the above objects additional, pre-defined objects, such as, for example, emailObject, can be used and are provided to the programmer in the form of finished objects ready for use.

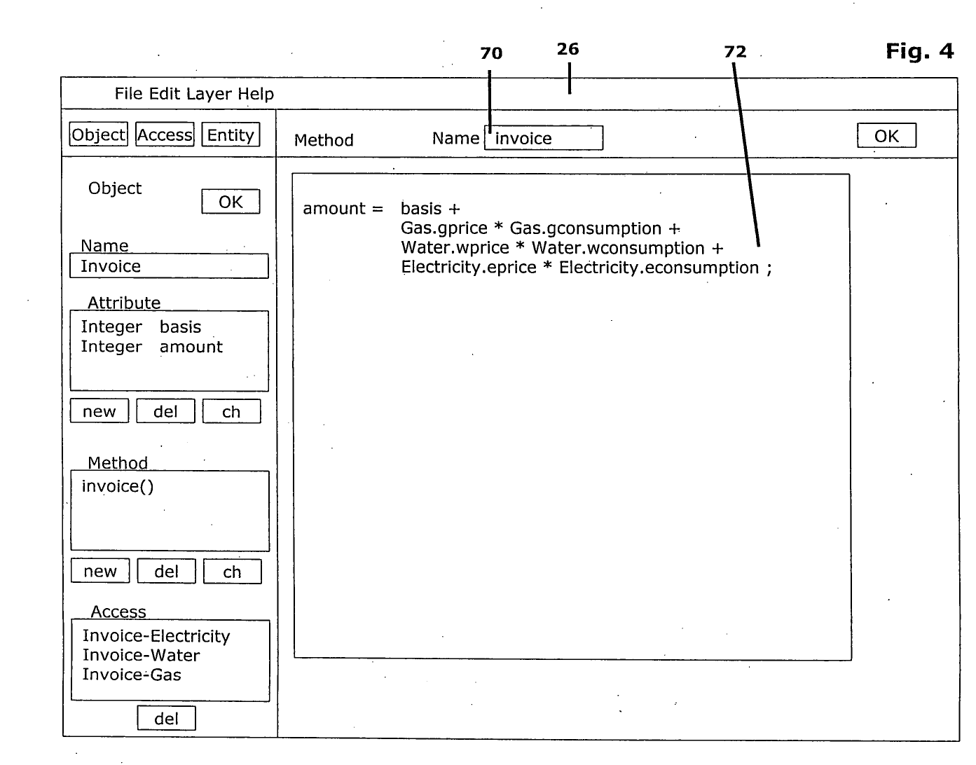

The method in the present example was generated by activating the button 42. Then the name of the method “invoice ()” is entered in the area 70 of the window. This is shown in FIG. 4. A formula can be entered using an editor 72. This formula serves to calculate the total amount which shall be invoiced. In the present case this is the sum of the multiplication product of the respective unit price and the respective consumption for electricity, gas and water. Such values were previously defined in the form of attributes of the other objects. The method “invoice ()” has the return value “amount”.

Objects and methods can be deleted with buttons 38 and 44. Changes can be made with buttons 40 and 46. By activating button 32 accesses between the objects can be established. The object “invoice”, for example, can access the other objects in the present example.

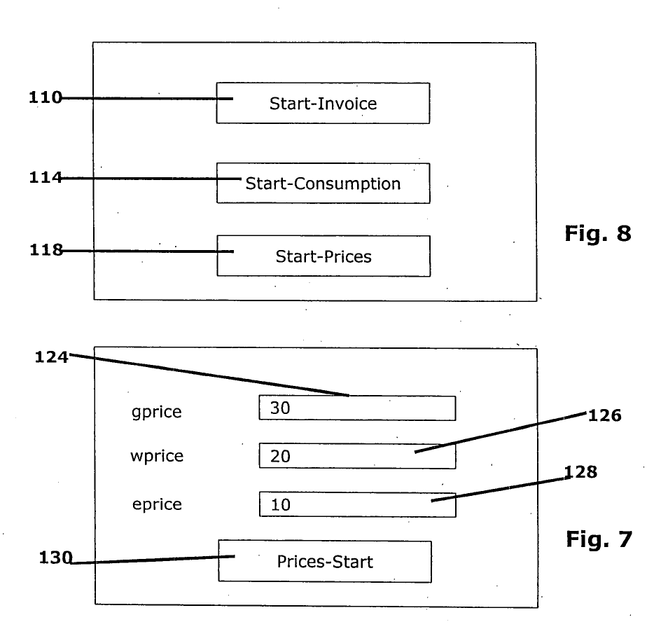

By selection in the menu 26, the window for modelling the process flow control can be opened. The programmer can set the states of the application in such a process flow modelling. Such states usually are dialogues. A dialogue is, for example, a window. In such a window a value can be requested and entered. An example for such a window is shown in FIG. 7. Furthermore, it can be defined, which data must be read out from which source, before this state is reached. This corresponds to the input-parameters of a dialogue. Furthermore, it can be defined, which data must be written and where the data shall be written into, if this state is reached. This corresponds to the output-parameters of a dialogue. The definitions relate to the objects defined in the application-specific logic and entities, as well as further objects which are made use of, and the program users.

Furthermore it is defined by events which following state shall come. This means that for the respective events it can be modelled to which state a transition shall occur. Such an event is, for example, the activation of a button or the calculation of a value. After executing an action the return value of the execution can be used. The return values of the methods and finders are offered for this purpose. When modelling an event, such as, for example, a button leading to a new dialogue, this is represented by an arrow.

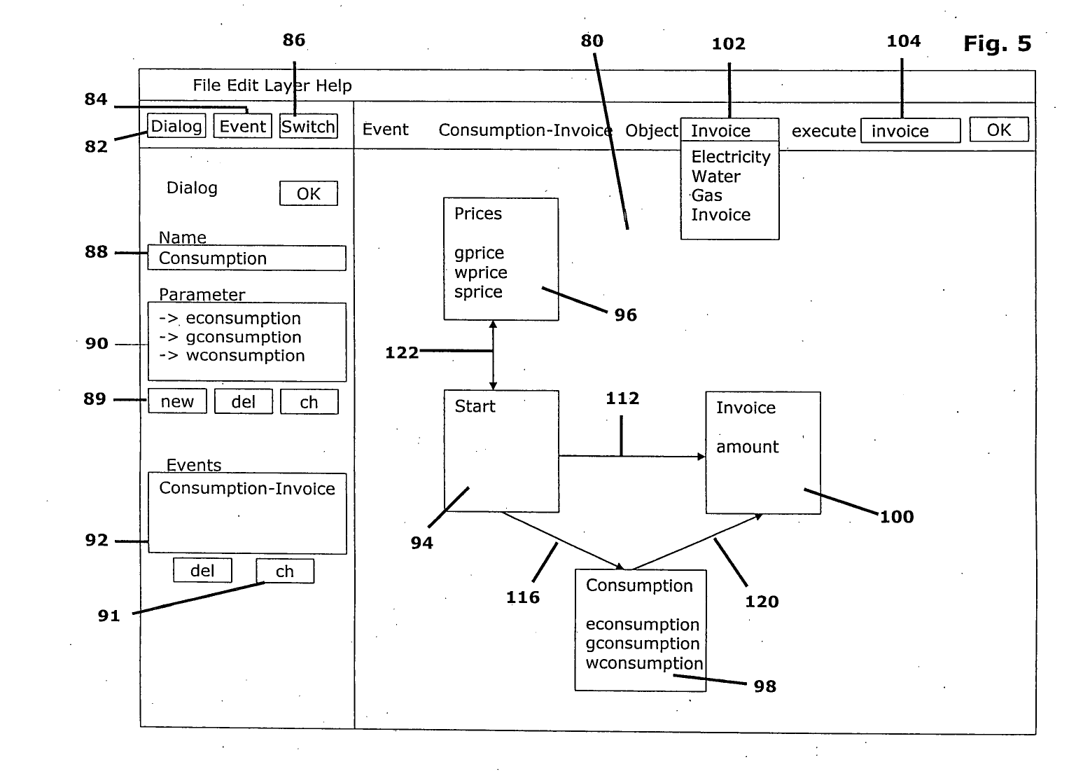

For modelling the process flow control the window as shown in FIG. 5 is opened through the menu 26 in the present example. This is also a modelling window, which means, that the programming is carried out by entering of graphical symbols. For this purpose a drawing area 80 is provided.

By means of buttons 82, 84 and 86 dialogues, events and switches can be generated. A switch is a graphic knot in the model. The graphic knot describes different possible following states which can occur depending on the return values of methods or finders.

The dialogues can be named in an input area 88. Similar to the procedure carried out with objects the components of the process flow control receive names in the input area 88. A button 89 is provided to create parameters for the dialogues. The events can be changed or processed by activating button 91. In the present example the starting dialogue “start” is created. With this dialogue the application is started. Furthermore the prices can be changed. For this purpose a dialogue 96 is provided. For entering the consumption a dialogue 98 is provided. This dialogue comprises the input areas “electricity consumption”, “water consumption” and “gas consumption”. The respective window of the program when it is executed is shown in FIG. 7. The event “consumption-invoice” is provided for the user in this window. The event is designated with numeral 120. Furthermore an object (invoice) is entered for this event and the method “invoice” (FIG. 4). This is effected in input areas 102 and 104.

At this stage the application can already be exported, generated, compiled and executed without any further generation of the layout or data storage organization. The modelling result is stored in the development file.

The file is automatically generated without entering programming commands or any other programming code. It can be generated in any suitable notation, even in a notation which is non-public. The development file 12 is described in greater detail in FIG. 2.

In FIG. 2 boxes generally represent elements of the file, whereas arrows represent the relationships between the individual elements. The arrows are designated with the cardinalities.

Objects are designated by numeral 1. They may comprise any number of attributes 25 in the development file 16. This is represented by an arrow 31. The minimum number of attributes for objects 1 is one. The cardinality of the relationship “1:n” designated below the arrow 31 is therefore 1, i.e., 1 object and n, i.e., any number of attributes. However, the other direction shows, that each attribute is connected only with one object. The respective arrow is designated with numeral 33 and is marked with the cardinality 1:1.

The object 1 may also comprise any number of methods 11 and accesses 5. This is represented by arrows 35 and 37, respectively. Each method 11 is always comprised in one object 1. This is represented by an arrow 39. A table, designated by numeral 17, may comprise any number of accesses 5. An access 5 always comprises an object 1 or an entity 17. This is represented by arrows 41 and 43. An access 5 is always comprised in an entity 17 and an object 1. An entity 17 can comprise any number of tables. A table 31 may be comprised in more than one entity 17. A table 31 can comprise any number of columns 21. A column 21 is always comprised in a table 31. A table 31 may comprise any number of relations, generally designated with numeral 29. By designating a relation the user can establish relations between tables. A relation is the relation between data entries in different tables, for example: customer-address. A relation 29 always comprises a table 31. A relation 29 is always comprised in a table 1. A dialog, designated with numeral 3, may comprise any number of events, designated with numeral 7.

An event 7 may have more than one executes, designated with numeral 19. An execute is established between an event and an executable element, such as a method and a finder. An execute is always comprised in an event 7. An execute 19 can comprise a method 11 or a finder 23. A method 11 can be comprised in any number of executes 19. A finder 23 can be comprised in any number of executes 19. A switch 13 is always comprised in an event 7. A switch 13 may comprise any number of returns 27. A return 27 comprises one dialogue 3. A dialogue 3 may be comprised in any number of returns 27. A return 27 may be comprised in any number of switches 13. A dialogue 3 may comprise any number of parameters 9. A parameter 9 is comprised in a dialogue 3. An entity 17 indirectly comprises the column 21 through the table 31 comprising such column 21. A parameter 9 comprises an attribute 25 of an object 1 or a column 21 of an entity 17. The column is indirectly referenced through the entity 17. An attribute 25 may be comprised in any number of parameters 9. A column 21 may be comprised in any number of parameters 9. A layout, designated with numeral 45, may comprise a dialogue 3. A layout 45 may comprise the event 7 of a dialogue 3. A layout 45 may also comprise further layout-specific features. Finally, a parameter may have a direction.

The program developed in the form of a graphically represented model with the designer 12 is stored in the development file 16. Then a running programming code is generated with another program, the generator 15. The generator 15 may be a program of its own or part of the executing program. It mainly interprets the application-specific logical portion of the development file. This is done before the run-time of the generated program. This individual code structures, for example classes of objects, are “automatically” generated for the instantiation at a later stage. An executable program in a programming language is generated at this stage. In an alternative embodiment the programming code generated by the generator 15 is executed by a server. In this case the executable program 14 is located on the server.

The executing program 14 makes use of the development file 16 for executing the application. In such a way the communication between the two programs 12 and 14 is established through the development file 16. The executing program 14 can be suitable for different platforms, such as Solaris, Windows, etc. and for different architectures, such as J2EE or the like.

The interpretation of the development file is carried out according to the following method:

First of all a parsing step is carried out. In this step the information stored in the development file 16 is translated into a programming language. The proprietary code of the development file 16 is resolved and parsed into the respective programming language. Model-related keywords are provided. Such keywords allow the access to the specific elements of the application-specific logic.

For example:

In the case of an entity.

Loop (entity) {
Entity.delete ( )
}

is parsed to

| //prevents the overwriting of values of an instance | |
|---|---|
| //by using the same by the user. | |
| For | (entiy.count; i++) { |

entity2 = new entity ( ) ;
entity2.index = i;
entity2.load ( );
entity2.delete ( );

}

or

print (“xxx”);

is parsed to

System.out.print (“xxx”)

if Java is used as a programming language. It is understood, that any other language may have different commands. Such a different language may also be used, whatever is preferred by the user of the invention.

Furthermore the search conditions of the finder which has been modelled is parsed and translated to the used query language.

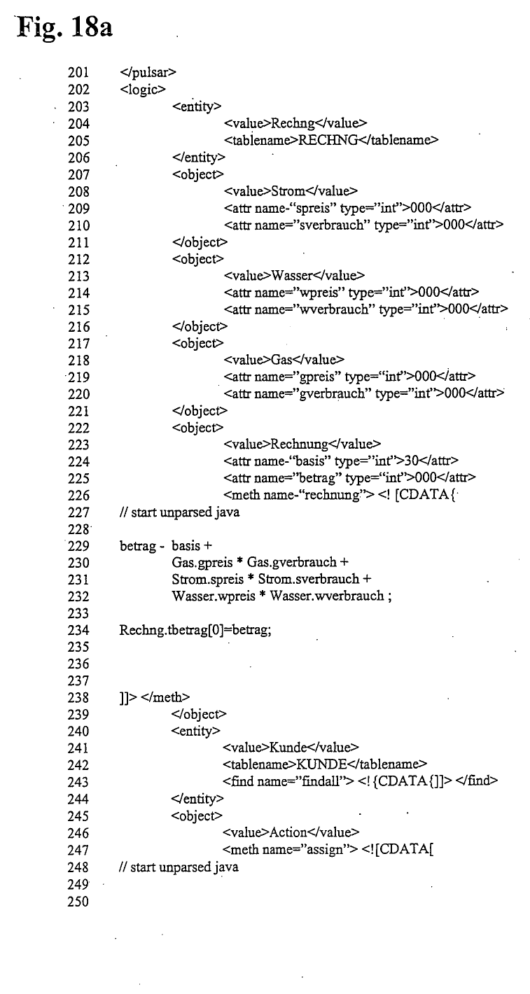

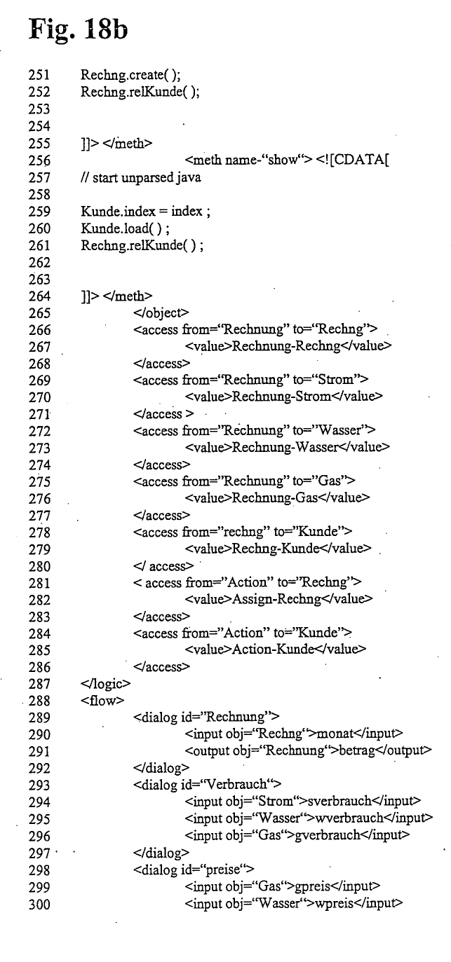

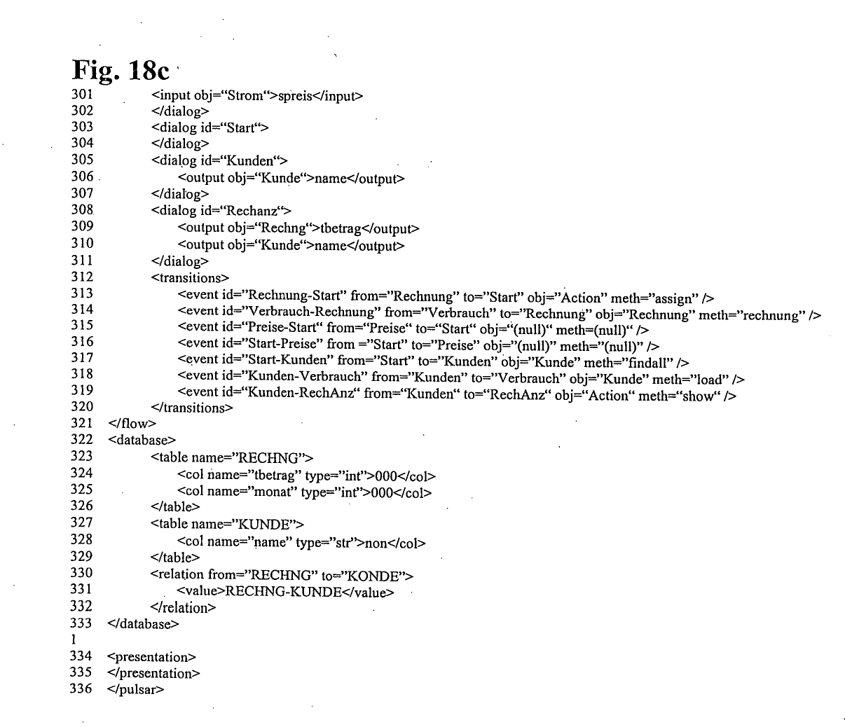

After parsing a basic class is provided to the executing program for calling the generated instances. A basic class is a portion of pre-programmed programming code. The basic class provides general methods for setting and reading attributes and for the execution of methods and finders. Furthermore the basic class comprises attributes which allow the executing program to check the state of the instance of a class. The basic class is provided with a method for setting objects. The methods are accessed in the model by access arrows from this object. Additionally pre-defined methods may be offered by the basic class. In Java each of such basic classes, for example, has a form, which is shown in FIG. 18. It can be loaded through the “reflection” by the class loader, which is a mechanism specific for Java.

The individual lines of the example for a basic class are designated by numerals 201 to 220. In lines designated with numerals 203 to 206 internal variables can be found, which are used to describe the state of the derived instantiated classes. In the line, designated with numeral 208 an abstract method for setting of attribute values by the state machine for derived instantiated classes is defined. Line 210 shows an abstract method for setting member objects. Such member objects are accessible by “Access”. The member objects are set by the state machine for derived instantiated classes. Lines 212 to 216 represent a method for checking attribute values by the state machine. This method is overwritten by the instantiated classes. Lines 17 to 18 represent an abstract method for executing methods and finders by means of the name of the method or finder to be executed. The name is transmitted in the form of a method parameter.

Furthermore general methods for the use by the generated instances and the state machine may be provided in such a basic class.

In the language C++ a specific class loader must be generated by the development file. The class loader instantiates the specific classes during run time. The user, therefore, does not need to know such classes. The user operates directly with instances in the storage. In the language C such a basic class must be declared by aggregated structure definitions.

After the generation of the basic class the classes of the modelled instances can be generated by the generator 15. This is effected by iteration over the objects of the development file. Imports and includes are generated during this procedure, the class basis is generated and finally the object type (object or entity) is read.

For the interpretation of the development file the following actions are carried out in any convenient order:
generating of the declaration of references to the member objects of the development file and iterating the accesses of the development file for generating specific class names;
generating of attributes. For this purpose the tables of the development file are scanned in the case of entities, to generate attributes corresponding to the columns. The attributes are read out of the development file. In the case of entities the attributes are declared in the form of arrays, collections or plural-space holders;
generating of a “getAttributeByName” method, returning the attribute value of the generated class by means of the transferred Parameter;
generating of “setObjectByName” for setting the member objects using their names. With such a method the instantiated classes which are accessible through Access are allocated to the corresponding member variables;
generating of methods. Such methods are, for example, “store” or “clear” for storing data or re-initialize objects of “save”, “create”, “load” and “delete” for saving, creating, loading and deleting the contents of a table when entities are used;
reading of information from the development file to generate the query language relating to the data base.
generating of relators and separators for creating and deleting persistent knots between entities if a relationship is modelled between two entities on the data base level;
generating finders;
generating a FinderFromRelation;
generating of the general executing method “execute” for the use by the state machine to call methods on instantiated classes. The method “execute” is generated in such a way that in a query the string transferred in the form of a parameter is compared to the methods of a class. If the string is identical to the method the respective method is called. The finder, the methods and the predefined methods of the basic class must be considered.

After the interpretation of the development file, it is automatically compiled, linked and deployed by a script run of the generator 15 or the executing program 14 or the designer 12. An executable program is generated which is executed by the interpreter, i.e. by the state machine.

When the program is executed for the very first time the following steps are performed:
initially generating a data base connection;
initially generating objects and relations;
initially generating data base tables if they are not present yet;
initially generating connection tables, if they are not present yet;
setting the start dialogue as the active dialogue;

Each time the program is run the following steps are performed:
reading request parameters. These are the input parameters of the active dialogue from the development file;
creating new objects and relations for the dialogue, if they are provided for in the development file;
reading an occurring event from the request;
if an event has occurred:
   execute (if present); For this purpose data selected by the program user must be transferred or the entity state corresponding to the data selected by the user must be achieved. An example for something like this is the loading of a selected table contents into the corresponding entities;
   reading transitions;
   reading switches, if present;
   setting a new dialogue;
creating a new dialogue. For this purpose the layout information for this dialogue is read and the output attributes for the dialogue are read and presented in accordance with the read order. The input attributes for this dialogue are presented and the events are presented.

As a result a program is generated which provides dialogues and windows as they are shown in FIGS. 7 to 10 for the above described example for writing invoices.

In FIG. 8 the start window is shown. The start window corresponds to the rectangle 94 in FIG. 5. Now, three actions are possible. Activating button 114 and calculating the total amount of the invoice according to arrow 112 in FIG. 5. Activating button 114 and entering the relevant consumption data according to arrow 116 in FIG. 5. Activating button 118 and entering prices according to arrow 122 in FIG. 5

When button 118 is activated a window as shown in FIG. 7 is opened. Now prices can be entered and changed. In other words: through dialogue parameters the attribute values of the instances in the store can be changed for the objects. For this purpose input areas 124, 126 and 128 are provided. Alternatively, dialogue parameters can be defined which use input parameters which are determined by allocation between the attributes of an entity and the attributes of an object. By activating button 130 the user returns to the start menu. This corresponds to the opposite direction of arrow 122 in FIG. 5. Further options are not provided. Therefore there are no further arrows modelled onto the dialogue rectangle 96 in FIG. 5.

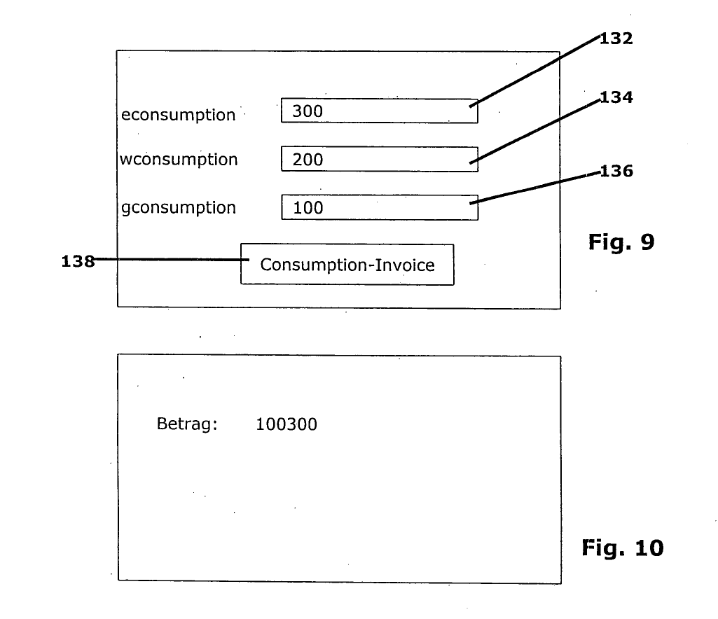

If the button 114 in FIG. 8 is activated a window as shown in FIG. 9 is opened. In this window the consumption values may be entered or changed. For this purpose input areas 132, 134 and 136 are provided. These input areas correspond to the three input parameters “electricity consumption”, “water consumption” and “gas consumption” which were modelled for the dialogue 98 in FIG. 5. By activating the button 138 the total amount is calculated and displayed in a new window corresponding to FIG. 10. This corresponds to arrow 120 in FIG. 5. Further options, for example a button for returning to the start dialogue are not modelled. The event 120 starts the calculation “consumption-invoice” as it was entered with the editor. The dialogue 100 “invoice” in FIG. 5 is started afterwards. There, the invoicing amount is displayed. The dialogue is shown in FIG. 10. This window cannot be left because no such arrow leading away from the dialogue was modelled. Accordingly, no corresponding button is provided.

By activating button 110 in FIG. 8 only the total amount for invoicing is displayed without previously entering data.

Apart from the described modelling of the application-specific logic and the process flow control the data storage can also be modelled. The data storage comprises tables with columns. In the columns data of the type “integer”, “string”, “float”, “date”, “time”, “binary large objects” and the like are stored. Such tables can be created. However, existing tables may also be used. By entering of relations, the user can determine which relations shall be established between the tables. A relation is a relationship between data entries of various tables, for example: customer-address.

Numbers (cardinalities) for such relations can be set also. Such a number is, for example, the number of addresses which can be stored per customer. Furthermore complex data base models can be developed providing data base triggers as executable elements of the application-specific logic. A data base trigger, for example, starts actions after an access to defined table columns or certain values. The triggers can be used as elements of the application-specific logic by the process flow control. Also transaction elements, such as commit or rollback may be integrated.

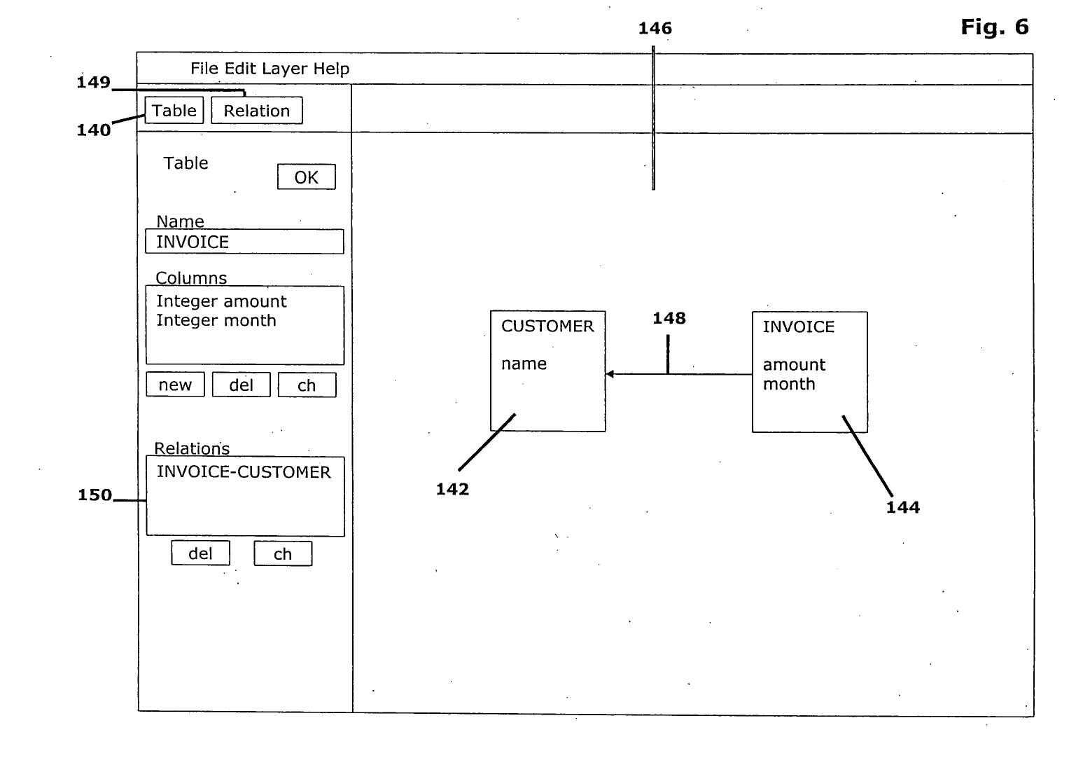

From the menu 26 the user can open the window of the user interface which is shown in FIG. 6. This window is provided for modelling the data storage. The monthly invoice for each customer can be stored with the above program. By activating button 140 a table 142 “Customer” and a table 144 “Invoice” are created, if they do not already exist. These tables are represented by a rectangle in the drawing area 146. An attribute “string name” adapted to receive a string belongs to the table 142. Attributes “int amount” and “int month” having integer values belong to the table 144. In order to allocate the invoices to the individual customers a relation between the tables is established. This is represented by an arrow 148 the relation “invoice-customer” is shown in the area 150 and is created with button 149.

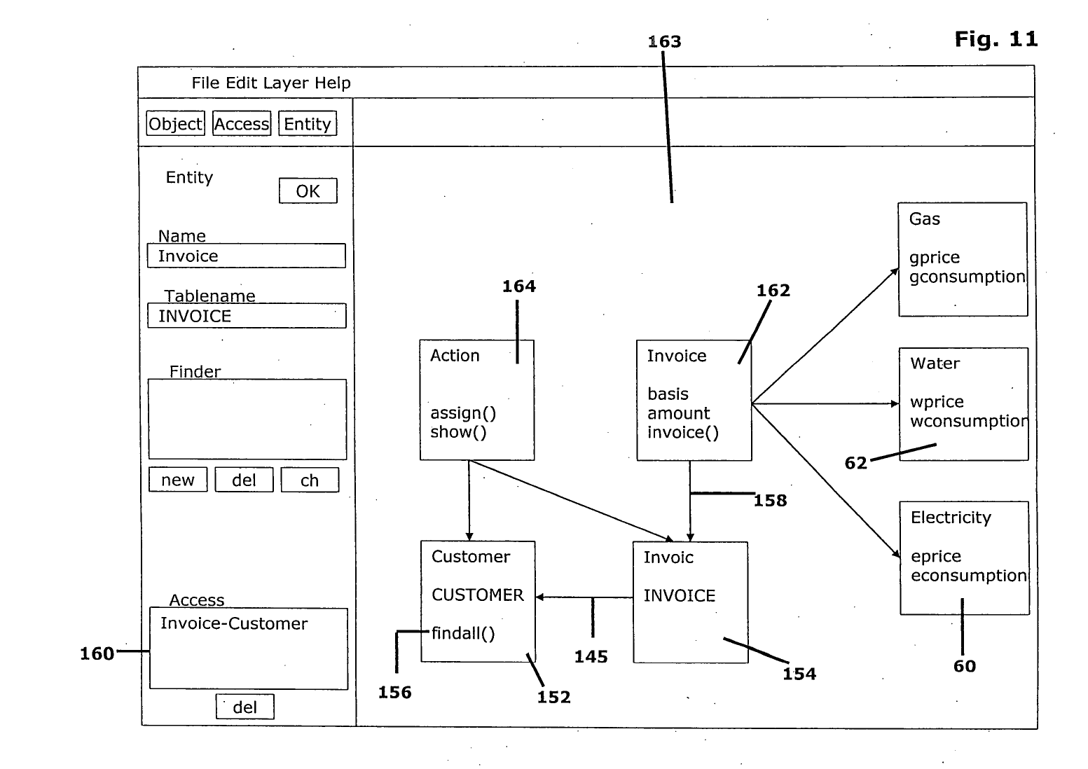

In the application-specific logic the objects “customer” and “invoice” of the type entity are created. These point at the respective tables. The model from FIG. 3, therefore, changes in the way as shown in FIG. 11. Additionally to the objects “invoice”, “gas”, “water” and “electricity” the entities 152 and 154 are created.

In order to display the customers a finder “findallo” 156 is applied to the customers 152. As no condition for the search is defined for the finder in the “customer”-table, all entries are found. Furthermore the calculated amount for the respective customer shall be entered in the “invoice” table 144. For this purpose an access “invoice-customer” 145 is generated by button 32 in the drawing area 163. The access is made from the entity “invoice” 154 to the entity “customer” 152.

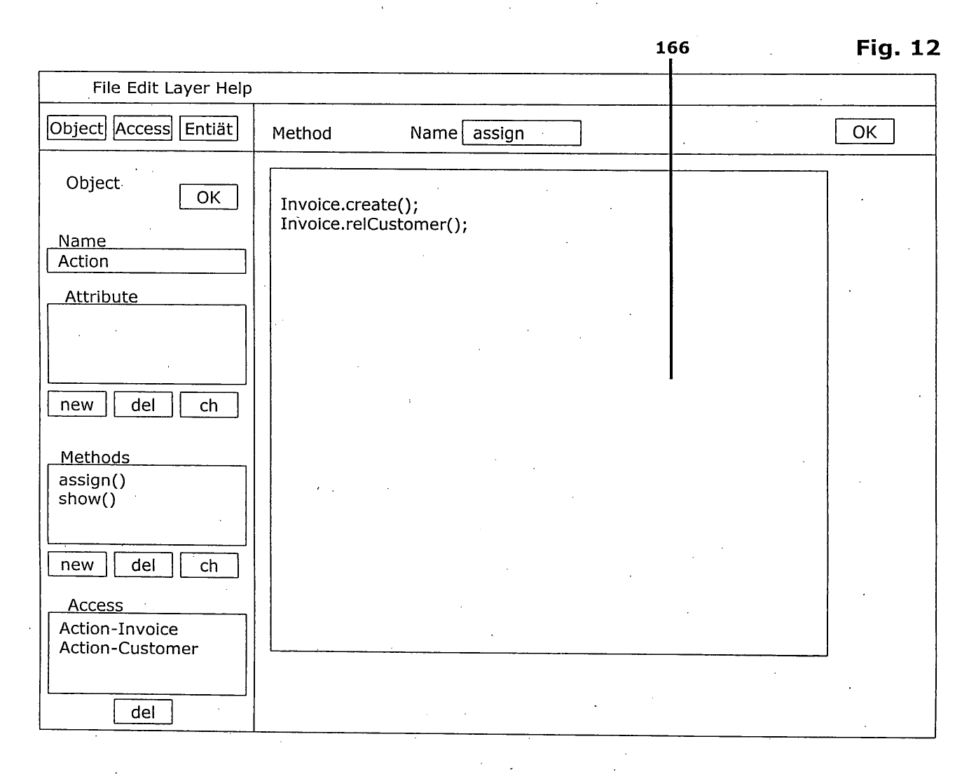

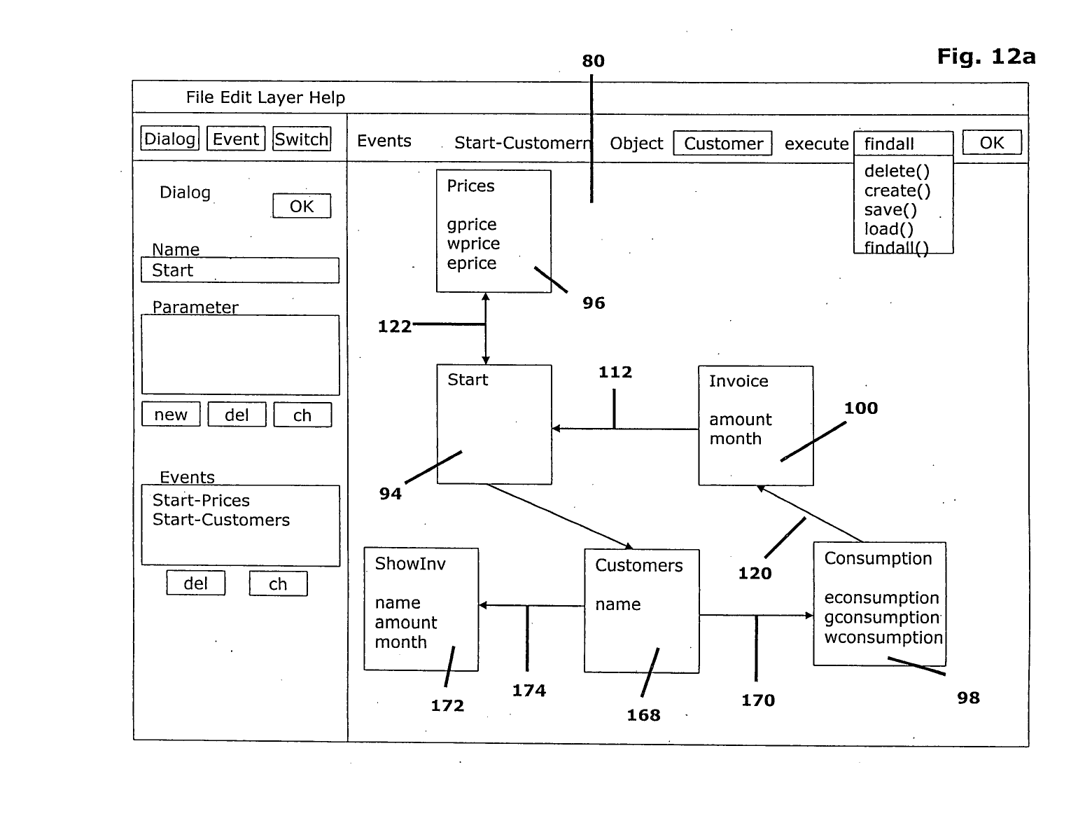

Furthermore an object “action” 164 is generated. The object has the method “assign()”. This method is used to directly establish the relation between customer and invoice without having to select a way through unnecessary dialogues. For this purpose the methods “assign” and “show” are created. The method is separately entered with the editor 166 as it is described above. This is shown in FIG. 12. The method “assign()” ensures that an entry for the invoice is made and connected with the active customer. In the same way the method “show ()” can be entered. The following input is made:
customer.index=index;
customer.load();
invoice.fromCustomer();
   It is understood, that this text which is entered in the form of a code does not constitute a full programming, but only a simplified possibility for using methods and repeating commands which can also be offered to a selection list and related in a dialogue with an event. The real generation of the programming code which is actually executed is effected only by interpretation of the model by the generator and the executing program in the state machine. Furthermore is its optionally possible to manually generate portions of programming code, for example for the calculation of formulas.

The method “show ()(” loads the customer selected in the dialogue and finds all invoices for the selected customer.

Furthermore the code of the method “invoice ()” entered with the editor 72 in FIG. 4 is changed. It is added:
Invoice.tamount[0]=amount;
   In other words: the actual amount of the invoice is entered into the stored table.

By adding this line the total amount of the invoice is inserted into the entity 154 immediately after the calculation according to the edited formula. It is assumed in the modelling of the dialogue that the “customer”-table 142 already has entries.

An event is created in the start dialogue 94, corresponding to the window in FIG. 8. With the occurring of such event the “findall”-finder of the entity “customer” 152 is called. The process flow control changes from the state in FIG. 5 in a way as it is shown in FIG. 12a.

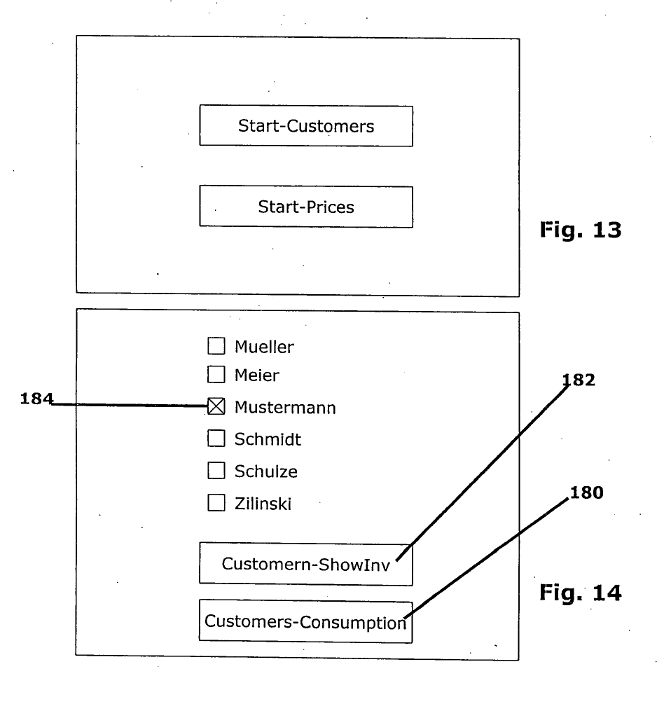

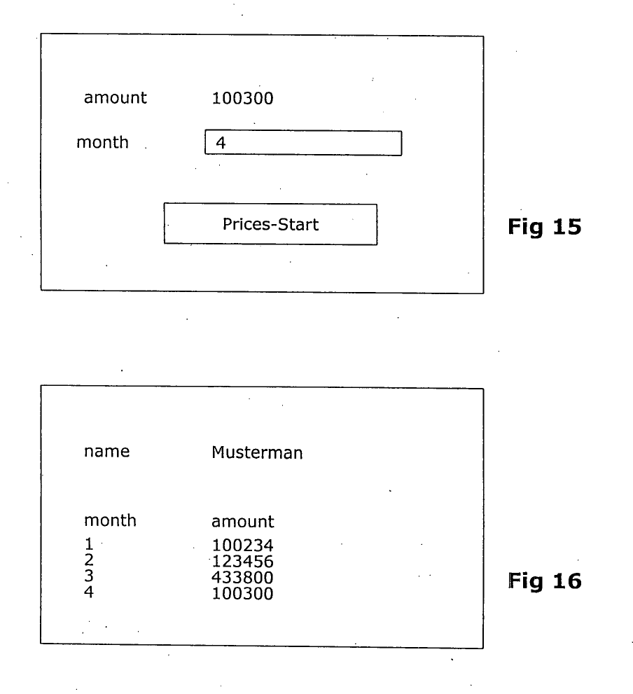

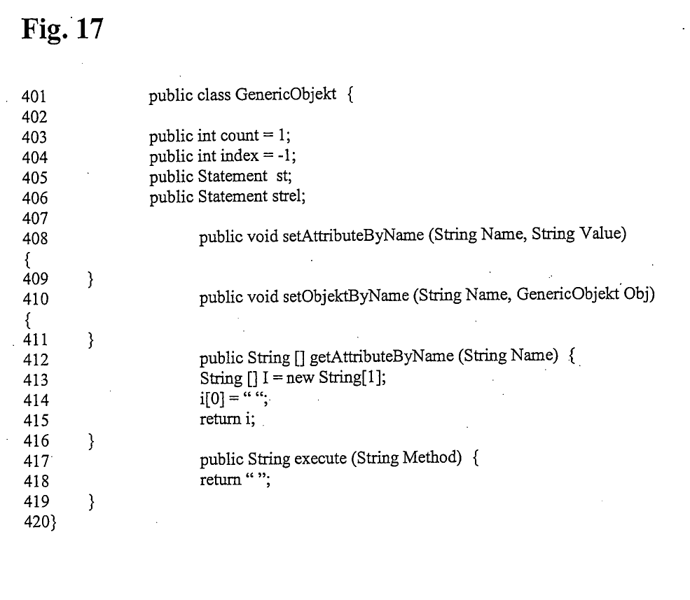

The new start window 94 is shown in FIG. 13. The corresponding customer-dialogue is shown in FIG. 14. An arrow 170 corresponds to the predefined method “load” of the entity “customer” 142. By activating the button 180 the method corresponding to the event “customer-consumption” is started. The contents of the entity “customer” is, therefore, the customer data set as selected on tick-box 184. As before in the dialogue “consumption” 98 represented in FIG. 9 the method “invoice ()” which is related to the event 120 can be activated by the button 138. By the aforementioned modification of the method “invoice ()” now the entity “invoice ()” 154 is filled with the calculated value. Furthermore the month of the invoice can be entered in the dialogue “invoice” 100. This is modelled as an additional dialogue parameter. In such a way the method “assign ()(” of the object “action” can be called at the event “invoice-start” 112. The method “assign ()” generates a persistent relation between the selected customer and the invoice. The method “create ()” generates the entry comprising the month and the calculated value in the invoice table. “relCustomer” generates the entry between the selected customer and the invoice in the relation table.

After the calculation the invoice for the customer can be displayed. For this purpose a further window “display invoice” 172 is generated. This is shown in FIG. 16. Upon activation of the event “customer-display invoice” represented by the arrow 174 the window 172 is opened. In the window “customers” (FIG. 14) a corresponding button 182 is installed. When activating the event, i.e. activating the button, the method “show ()” is called to display the specific invoices for the customers selected by activating a tick-box 184. According to the dialogue parameter definitions for the dialogue “display invoice” 172 the name of the customer, the month and the amount of the invoice is displayed. First of all, the selected customer is loaded in the method “show ()”. This is effected by
Kunde.index=index.

Afterwards the relation based finder “find from customer ()” is activated.

The corresponding development file has a form in the notation of XML as shown in FIGS. 18a, 18b and 18c. In this form the result of the development can be stored.

The lines designated with numerals 203 to 265 in FIG. 19 represent the entities and the objects of the application specific logic. Lines 240 to 244 represent, for example, the entity “customer” 152. Lines 240 to 244 represent, for example, the pointer of the entity “customer” 152. Lines 212 to 216 represent, for example the object “water” 62. Lines 214 to 215 represent, for example the attributes of the object “water” 62. Lines 222 to 239 represent, for example the object “invoice” 162. Lines 226 to 239 represent, for example the method of the object “invoice” 162. Lines 266 to 286 represent the access of the application specific logic. Lines 278 to 280 represent, for example the access “invoice customer”. Lines 289 to 311 represent the dialogues of the process flow control. Lines 298 to 302 represent, for example the dialogue “prices” 96. Line 299 represents, for example, the input dialogue parameter “gprice” of the dialogue “prices” 96. Line 291 represents, for example, the output dialogue parameter “amount” of the dialogue “invoice” 100. Lines 313 to 319 represent the events of the process flow control. Line 314 represents, for example, the event “consumption-invoice” 120. Lines 323 to 329 represent, for example, the table “Customer” 142. The line 328 represents, for example, the column “name” of the table “customer” 142. Lines 330 to 332 represent the relations of the data storage. The lines 330 to 332 represent, for example, the relation “invoice-customer” 148.

The dialogues and windows of the finished application are shown with a standard layout. For creating individual layout components line orientated presentation interfaces, for example HTML, as well as a pixel orientated interface, such as Delphi, are provided.

The programmer can make global settings for each dialogue. Images and texts with different script types can be placed with different backgrounds. Dialogue parameters and events, defined in the process flow control can be accessed to represent them in the finished application.

If the application is put into practice in the form of a batch or a service without user interface the layout component 18 of the designer program 12 is substituted by the interface definitions.

Additionally to the state machine interpreting the development file for executing the application a configuration machine is provided. The configuration machine also reads the development file. Furthermore it serves for importing and exporting data to and from external systems, for changing of default values and other run time setting.

1. A computer device for the generation of executable programs, comprising
(a) a user interface adapted to receive input data and provide output data, said user interface being provided for entering a model based on a program, said program comprising a plurality of executable commands;
(b) a generator means for generating individual programming code from said model;
(c) a state machine for executing said executable program based on said programming code;
(d) means for providing predefined programming code, said predefined programming code having the form of at least one basic class or other predefined code for providing repeating algorithms;
(e) said user interface having input means, said input means being designed such that the input of said executable commands is effected at least partially in a graphical form;
(f) means for selecting an entry point in parts of said predefined programming code for the state machine,
(g) said model based on said program comprising graphic symbols representing instantiated classes, and
(h) the user interface comprising means for defining a direct relation between said input and output of data by a program user and attributes of said instantiated classes.

2. A device according to claim 1, wherein said model based on said program additionally comprises graphic symbols representing states of the state machine and transitions thereof.

3. A device according to claim 1, wherein said user interface is adapted to graphically define a direct allocation between said input and said output data of said program user at the respective state and said attributes of said instantiated classes.

4. A device according to claim 1, wherein said instantiated classes comprise methods which are adapted to be executed at a state transition and said user interface comprises means for graphically initiating a direct allocation of events at a state transition to said methods by said program user.

5. A device according to claim 1, wherein storage means for persistent storage of data are provided and said instantiated classes comprise means for the persistent access to such data.

6. A device according to claim 1, wherein said executable program has a user surface and means for the graphic design of said surface said the executable program are provided.

7. A device according to claim 6, wherein said graphic design comprises a plurality of presentation elements and said means for the graphic design comprise inserting means for graphically entering said presentation elements.

8. A device according to claim 1, wherein means for storing said model based on said program in one continuous structure, especially in one single file are provided.

9. A device according to claim 5, wherein said data stored in said persistent storage means are interconnected establishing an interconnection and said model comprises graphic symbols representing said interconnections.

10. A method for the generation of executable programs comprising the method steps of:
(a) generating a graphic chart representing a model based on a program by inserting executable commands at least partially in graphical form;
(b) generating individual programming code from said model,
(c) executing said program based on said programming code by means of a state machine;
(d) providing predefined programming codes in the form of at least one basic class or other predefined code for providing for repeating algorithms, and executing said predefined programming codes;
(e) providing a state machine for executing said predefined programming codes and entering into said predefined programming code by means of said state machine,
(f) forming instantiated classes by means of graphic symbols, and
(g) using direct interfaces between instances and program users which are included in the model and which are generated by said state machine using said base classes.
